(19) United States
(12) Patent Application Publication
(10) Pub. No.: US 2024/0381243 A1
(43) Pub. Date: Nov. 14, 2024

(54) CELL RESELECTION METHOD AND CELL RESELECTION DEVICE

(71) Applicant: Beijing Xiaomi Mobile Software Co., Ltd., Beijing (CN)

(72) Inventor: Xiaofei LIU, Beijing (CN)

(73) Assignee: Beijing Xiaomi Mobile Software Co., Ltd., Beijing (CN)

(21) Appl. No.: 18/573,096

(22) PCT Filed: Jun. 24, 2021
(86) PCT No.: PCT/CN2021/102210

§ 371 Date: Dec. 21, 2023

(51) Int. Cl. H04W 48/20; H04W 48/10

(52) U.S. Cl. CPC H04W 48/20; H04W 48/10

(57) ABSTRACT

A cell reselection method, and including: determining a candidate cell; determining a target cell of the UE according to slice information supported by the candidate cell; and performing cell reselection according to the target cell.

### CROSS REFERENCE TO RELATED APPLICATION

The present application is a U.S. National Stage of International Application No. PCT/CN2021/102210, filed on Jun. 24, 2021, the entire content of which is incorporated herein by reference for all purposes.

### BACKGROUND

During cell reselection, UE performs selection based merely on signal quality of a cell or based on whether a network slice needed by the UE supports the cell, resulting in a possibility that a cell in which the UE resides after reselection is not a cell from which the UE may obtain a better-quality service.

### SUMMARY

In a first aspect, an example of the disclosure provides a cell reselection method, including: determining a candidate cell; determining a target cell of UE according to slice information supported by the candidate cell; and performing cell reselection according to the target cell.

In a second aspect, an example of the disclosure provides a cell reselection device. The device has a part of or all functions of a terminal device for implementing the method in the first aspect, for example, functions of a cell reselection device may have functions in a part of or all examples in the disclosure, or may have a function for independently implementing any example of the disclosure. The functions may be implemented through hardware or implemented by hardware executing corresponding software. The hardware or software includes one or more units or modules corresponding to the above functions.

In a third aspect, an example of the disclosure provides a communication device, including a processor, and the processor, when calling a computer program in a memory, executes the above method in the first aspect.

In a fourth aspect, an example of the disclosure provides a communication device, including a processor and a memory, the memory stores a computer program, and the processor executes the computer program stored in the memory so as to cause the device to execute the above method in the first aspect.

In a fifth aspect, an example of the disclosure provides a communication device, including: a processor and an interface circuit; the interface circuit is configured to receive a code instruction and transmit the code instruction to the processor; and the processor is configured to run the code instruction so as to execute the above method in the first aspect.

In a sixth aspect, an example of the disclosure provides a communication system, including the cell reselection device in the second aspect, or including the communication device in the third aspect, or including the communication device in the fourth aspect, or including the communication device in the fifth aspect.

In a seventh aspect, an example of the disclosure provides a computer-readable storage medium, configured to store instructions, and the instructions, when executed, implement the above method in the first aspect.

In an eighth aspect, the disclosure further provides a computer program product including a computer program, and the computer program, when running on a computer, causes the computer to execute the above method in the first aspect.

In a ninth aspect, the disclosure provides a chip system, including at least one processor and interface and configured to support a terminal device to implement the functions involved in the first aspect, for example, determining or processing at least one type of data and information involved in the above method. In a possible design, the chip system further includes a memory, and the memory is configured to store computer programs and data necessary for the terminal device. The chip system may be composed of chips, or may also include a chip and other discrete devices.

In a tenth aspect, the disclosure provides a computer program, and the computer program, when running on a computer, causes the computer to execute the above method in the first aspect.

### BRIEF DESCRIPTION OF THE DRAWINGS

In order to describe technical solutions in the examples of the disclosure or the background more clearly, accompanying drawings needed by the examples of the disclosure or the background will be described below.

FIG. 1 is a schematic structural diagram of a communication system provided by an example of the disclosure.

FIG. 2 is a schematic flowchart of a cell reselection method in an example of the disclosure.

FIG. 3 is a schematic flowchart of a cell reselection method in another example of the disclosure.

FIG. 4 is a schematic flowchart of a cell reselection method in another example of the disclosure.

FIG. 5 is a schematic flowchart of a cell reselection method in another example of the disclosure.

FIG. 6 is a schematic flowchart of a cell reselection method in another example of the disclosure.

FIG. 7 is a schematic flowchart of a cell reselection method in another example of the disclosure.

FIG. 8 is a schematic structural diagram of a cell reselection device in an example of the disclosure.

FIG. 9 is a schematic structural diagram of a communication device in an example of the disclosure.

FIG. 10 is a schematic structural diagram of a chip in an example of the disclosure.

### DETAILED DESCRIPTION

Examples of the disclosure are described in detail below, instances of the examples are shown in the accompanying drawings, and the same or similar reference numerals represent the same or similar elements or elements with the same or similar functions all the time. The examples described with reference to the accompanying drawings below are examples and are intended to explain the disclosure but are not understood as a limitation on the disclosure.

The disclosure relates to the technical field of communication, and in particular to a cell reselection method and a cell reselection device.

Terms involved in the disclosure are introduced firstly for convenient understanding.

### 1. Radio Resource Control (RRC)

RRC is also called radio resource management (RRM) or radio resource allocation (RRA) and means that radio resource management, control and scheduling are performed by a certain strategy and means, limited wireless network resources are utilized as fully as possible while a demand of quality of service is met so that it is guaranteed that a planned coverage is reached, and a service capacity and a resource utilization ratio are improved as much as possible.

In order to better understand a cell reselection method provided by an example of the disclosure, a communication system used in the example of the disclosure is described below firstly.

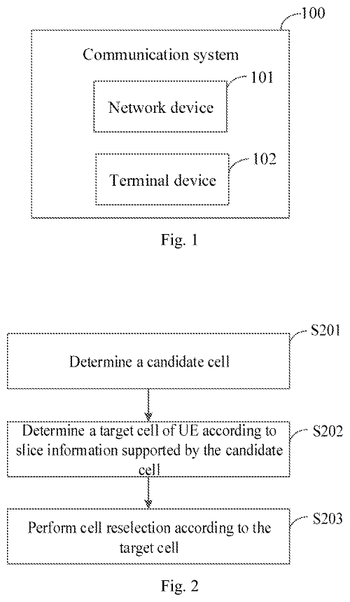

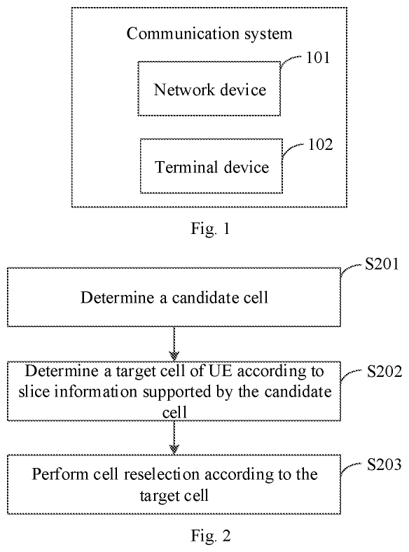

FIG. 1 is a schematic structural diagram of a communication system 100 provided by an example of the disclosure. As shown in FIG. 1, the communication system 100 may include, but is not limited to, one network device and one terminal device. The number and form of devices shown in FIG. 1 are merely an example and do not constitute a limitation on the example of the disclosure, two or more than two network devices and two or more than two terminal devices may be included in actual application. The communication system 100 shown in FIG. 1 including one network device 101 and one terminal device 102 is taken as an example.

The technical solutions of the example of the disclosure may be applied to various communication systems, for example, a long term evolution (LTE) system, a 5^{th} generation (5G) mobile communication system, a 5G new radio (NR) system, other future new mobile communication systems, or the like.

The network device 101 in the example of the disclosure is an entity on a network side for transmitting or receiving a signal. For example, the network device 101 may be an evolved NodeB (eNB), a transmission reception point (TRP), a next generation NodeB (gNB) in an NR system, a base station in other future mobile communication system, an access node in a wireless fidelity (WiFi) system, or the like. The example of the disclosure does not limit a specific technology and a specific device form adopted by the network device. The network device proposed by the example of the disclosure may be composed of a central unit (CU) and a distributed unit (DU). The CU may also be called control unit. A CU-DU structure may be adopted for splitting the network device, for example, splitting protocol layers of a base station, functions of a part of protocol layers are under centralized control in the CU, and functions of a part of or all protocol layers are distributed in the DU which is under centralized control by the CU.

The terminal device 102 in the example of the disclosure is an entity, for example, a mobile phone, on a user side for receiving or transmitting a signal. The terminal device may also be called a terminal, user equipment (UE), a mobile station (MS), a mobile terminal (MT), or the like. The terminal device may be an automobile, a smart car, a mobile phone, a wearable device and a pad which have a communication function, a computer with a wireless transceiving function, a virtual reality (VR) terminal device, an augmented reality (AR) terminal device, a wireless terminal device in industrial control, a wireless terminal device in self-driving, a wireless terminal device in a remote medical surgery, a wireless terminal device in a smart grid, a wireless terminal device in transportation safety, a wireless terminal device in a smart city, a wireless terminal device in a smart home, or the like. The example of the disclosure does not limit a specific technology and a specific device form adopted by the terminal device.

It may be understood that the communication system 100 described in the example of the disclosure is intended to describe the technical solution of the example of the disclosure more clearly but does not constitute a limitation on the technical solution proposed by the example of the disclosure, and those ordinarily skilled in the art may know that with evolution of a system architecture and emergence of a new service scene, the technical solution proposed by the example of the disclosure is also applicable to similar technical problems.

Examples of the disclosure provide a cell reselection method and a cell reselection device, which may be used for solving a problem of improving channel estimation accuracy in the related art.

A cell reselection method and device proposed by the disclosure are introduced in detail below with reference to the accompanying drawings.

FIG. 2 is a schematic flowchart of a cell reselection method in an example of the disclosure. An executive body for the method is UE. As shown in FIG. 2, the method includes steps S201-S203.

In S201, a candidate cell is determined.

In an implementation, when being in an idle state and/or an inactive state, the user equipment (UE) continuously performs reselection on a cell in which the UE resides, so that the UE may reside in a cell with a higher priority and/or a better signal quality, and thus the UE may obtain a higher-quality service.

In the example of the disclosure, a network resource is divided into at least one network slice, a cell which may support a corresponding network slice is selected and configured for the UE based on a demand of the UE, so that the UE may obtain a differentiated service provided by the network slice, and reasonable utilization of the network resource may be implemented while an experience degree of a user is optimized.

The network slice may provide a complete end-to-end virtual network for the user, and by dividing the network resource, a 5G network slice may provide a differentiated service for the user so as to meet various demands of the user. In an implementation, the network slice may provide a resource for the cell, so that the cell may provide a service for the UE. When the UE is in the idle state and/or the inactive state or similar states, the cell to which the UE belongs needs to be continuously reselected, so that the UE may reside in the cell with the higher priority and/or the better signal quality, and thus the UE may obtain the higher-quality service.

The cell may provide the service for the UE within a coverage of the cell, and coverages of different cells are different, so the candidate cell during cell reselection of the UE may be determined from cells which may cover the UE based on a current geographical location where the UE is located.

In an example, the candidate cell may be obtained based on signal quality of the cell covering the UE, a slice supported by the cell, or other set conditions.

In S202, a target cell of the UE is determined according to slice information supported by the candidate cell.

In the example of the disclosure, network slices supported by different candidate cells may be the same or not. After the candidate cells are obtained, the network slices supported by the candidate cells may be obtained by reading attribute information of the candidate cells, and thus the slice information supported by the candidate cells and the number of slices supported by the candidate cells are determined.

The slice information of the network slices may include types of the slices, priorities of the slices or other related parameters. The target cell of the UE may be determined from the candidate cells based on the slice information.

In order to guarantee that the cell in which the UE resides after reselection may provide the better-quality service for the UE, in an example, the target cell of the UE may be determined based on the slices supported by the candidate cells and a slice needed by the UE.

In an example, the number of slices needed by the UE and supported by each candidate cell may be compared, at least one candidate cell supporting the greatest number of slices is obtained, and thus the target cell of the UE is determined from the candidate cell.

In an example, priorities of the slices needed by the UE and supported by each candidate cell may be obtained and compared, at least one candidate cell supporting the highest-priority slice is obtained, and thus the target cell of the UE is determined from the candidate cell.

In an example, at least one candidate cell supporting the highest-priority slice and the greatest number of the slices may be obtained based on the number and priorities of the slices needed by the UE and supported by each candidate cell, and thus the target cell of the UE is determined from the candidate cell.

In S203, cell reselection is performed according to the target cell.

In the example of the disclosure, a reselected cell in which the UE may reside after reselection may be determined based on the target cell.

In an implementation, in order to guarantee quality of the cell in which the UE resides after reselection, determining the reselected cell may be implemented based on the target cell. Further, a signal quality parameter of the determined target cell is judged again based on a set standard. Thus, the cell in which the UE resides after reselection may provide the better-quality service for the UE.

For example, it is assumed that a current obtained target cell is A and a standard set based on a signal quality parameter is P, a signal quality parameter of the target cell A is obtained and compared with P. If the target cell A meets the standard corresponding to P, it may be determined that the target cell A may be the reselected cell in which the UE resides after reselection.

In the cell reselection method proposed by the disclosure, the candidate cells are determined, the target cells are obtained based on the slice information of the network slices supported by the candidate cells. Further, the target cells are screened, and the reselected cell determined by the UE is obtained. In the disclosure, the candidate cells are obtained based on the signal quality parameters of the cells. Thus, the signal quality of the candidate cells is better than that of other cells of non-candidate cells. Additionally, the target cells are determined from the candidate cells based on the slice information supported by the candidate cells. Therefore, the target cell can maximize the support for a slice needed by the UE, and thus the cell in which the UE resides after reselection can provide a better-quality differentiated service for the UE.

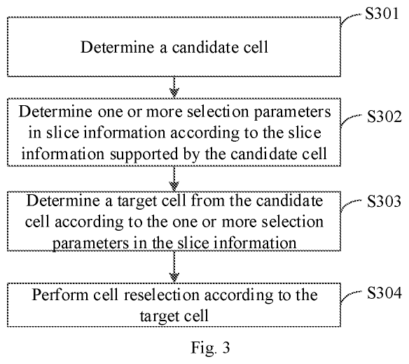

Based on the above example, further understanding may be achieved with reference to FIG. 3, and FIG. 3 is a schematic flowchart of a cell reselection method in another example of the disclosure. An executive body for the method is UE. As shown in FIG. 3, the method includes steps S301-S304.

In S301, a candidate cell is determined.

In the example of the disclosure, in order to guarantee that a cell in which the UE resides after reselection may provide a better-quality service for the UE compared with a current cell in which the UE resides, in an example, a range of the candidate cell may be determined from cells covering the UE by obtaining slice-specific network configuration information supported by the cells. In an example, the range of the candidate cell may be determined from the cells covering the UE by comparing signal quality parameters of the cells.

As a possible implementation, the UE may obtain the slice-specific network configuration information of the cells from the cells covering the UE.

The candidate cell is determined according to the slice-specific network configuration information in a case that the slice-specific network configuration information is obtained.

In the example of the disclosure, the network configuration information includes one or more configuration parameters, and the UE may compare the cells based on the configuration parameters in the network configuration information and then determine the range of the candidate cell.

The configuration parameter may include, but not limited to, at least one of a slice-specific first signal quality parameter threshold, the slice-specific number N of cells or a slice-specific signal quality deviation value.

It needs to be noted that the above configuration parameters can be configured for at least one slice or at least one slice group. It may be understood that any one of the above configuration parameters can be configured for one slice or one slice group composed of a plurality of slices, or any two or more than two of the above configuration parameters can be configured for one slice or one slice group composed of the plurality of slices, which is not limited here.

In an example, a cell with a signal quality parameter being greater than or equal to the first signal quality parameter threshold may be obtained based on the slice-specific first signal quality parameter threshold obtained by the UE, and further, the cell with the signal quality parameter being greater than or equal to the first signal quality parameter threshold is determined as the candidate cell.

In an example, sorting may be performed based on the signal quality parameters of the cells and the slice-specific number N of the cells obtained by the UE, and N cells are obtained from the cells based on a sorting result and determined as the candidate cells.

In an example, a signal quality deviation value of each cell is obtained based on the slice-specific signal quality deviation value obtained by the UE, and then cells within a deviation value range are determined as the candidate cells.

The candidate cells may be determined based on one of the configuration parameters in the above slice-specific network configuration information, or based on a plurality of the configuration parameters, which is not limited here.

The slice-specific network configuration information is carried by a broadcast system message and/or dedicated signaling. Specifically, the UE may obtain the slice-specific network configuration information through the dedicated signaling, for example, radio resource control (RRC) signaling, or through the broadcast system message.

When the UE simultaneously obtains the slice-specific network configuration information carried by the dedicated signaling and the slice-specific network configuration information carried by the broadcast system message, the UE using the slice-specific network configuration information carried by the dedicated signaling may be understood as the slice-specific network configuration information carried by the dedicated signaling covering the slice-specific network configuration information carried by the broadcast system message in this scene.

As another possible implementation, the candidate cells are determined based on the signal quality parameters of the cells from the cells covering the UE. In an implementation, when the UE is to obtain the slice-specific network configuration information, the slice-specific network configuration information may not be obtained. In the example of the disclosure, the UE judges whether the slice-specific network configuration information of the cells is obtained, and the candidate cells are determined based on the signal quality parameters of the cells in a case that the slice-specific network configuration information is not obtained.

In this scene, in order to guarantee the quality of service provided for the UE to the maximum degree, a cell with the best signal quality parameter may be selected from the cells and determined as the candidate cell. Further, the UE may obtain the signal quality parameters of the cells covering the UE and sort the obtained signal quality parameters, and a signal quality parameter of a cell ranking the first in a sort is the best in the cells covering the UE, so that the cell may be determined as the candidate cell of the UE.

In an example, the UE may obtain cells meeting a criterion S from the cells covering the UE, namely, cells with receiving power (Srxlev) in search being greater than 0 dB and received signal quality (Squal) in search being greater than 0 dB, sorting is performed based on signal quality parameters of the cells meeting the criterion S, and the cell ranking the first is obtained and determined as the candidate cell of cell reselection of the UE.

In S302, one or more selection parameters in the slice information are determined according to slice information supported by the candidate cell.

After the candidate cells are obtained, the obtained candidate cells may be further screened, and the UE may read the slice information of slices supported by the candidate cells and further determine the target cell of the UE from the candidate cells based on the slice information.

After the UE obtains the slice information supported by the candidate cells, one or more selection parameters of the slices may be obtained, and the selection parameter may include, but not limited to, a slice priority and the number of slices.

The slice information supported by the candidate cells and obtained by the UE being carried by a broadcast system message and/or dedicated signaling may be understood as the UE being able to obtain the slice information supported by the candidate cells from the broadcast system message, or from the dedicated signaling, for example, the RRC signaling. Further, when the UE simultaneously obtains the slice information supported by the candidate cells from the broadcast system message and the slice information supported by the candidate cells from the dedicated signaling, the UE performing screening of the target cells based on the slice information supported by the candidate cells and obtained from the dedicated signaling, may be understood as the slice information supported by the candidate cells and carried by the dedicated signaling covering the slice information supported by the candidate cells and carried by the broadcast system message in this scene.

In S303, a target cell is determined from the candidate cell according to the one or more selection parameters in the slice information.

In the example of the disclosure, after the UE obtains the selection parameter in the slice information supported by the candidate cells, the target cell may be determined from the candidate cells based on further processing for the selection parameter of the slices.

For example, a cell supporting the highest-priority slice may be determined from the candidate cells based on the slice priority, and then the target cell is determined; and for another example, a candidate cell which may support the greatest number of slices needed by the UE may be determined from the candidate cells based on the number of slices, and then the target cell is determined.

The number of candidate cells obtained by screening the candidate cells based on the selection parameter in the slice information is uncertain, the UE, after cell reselection, resides in merely one cell which may provide a good-quality service for the UE, and thus, the candidate cells obtained by screening need to be further processed so as to obtain the target cell.

Further, the candidate cells obtained by screening the candidate cells based on the selection parameter in the slice information may be determined as candidate target cells of the UE.

In an example, the candidate target cells are further screened based on different cases of the number of the obtained candidate target cells so as to determine the target cell.

For example, if the number of candidate target cells is two or more than two, a candidate target cell with the best signal quality parameter is obtained by comparing signal quality parameters of the candidate target cells, and determined as the target cell. For another example, if the number of candidate target cells is one, the current candidate target cell may be determined as the target cell.

In S304, cell reselection is performed according to the target cell.

The step S304 may refer to related detailed content in the above example and is not described in detail here.

In the cell reselection method proposed by the disclosure, the candidate cells are determined, the target cells are obtained based on the slice information of the network slices supported by the candidate cells. Further, the target cells are screened, and the reselected cell determined by the UE is obtained. In the disclosure, the candidate cells are obtained based on the signal quality parameters of the cells, so that the signal quality of the candidate cells is better than that of other cells of non-candidate cells. Additionally, the target cell is determined from the candidate cells based on the slice information supported by the candidate cells, so that the target cell can maximize the support for a slice needed by the UE, and thus the cell in which the UE resides after reselection can provide a better-quality differentiated service for the UE.

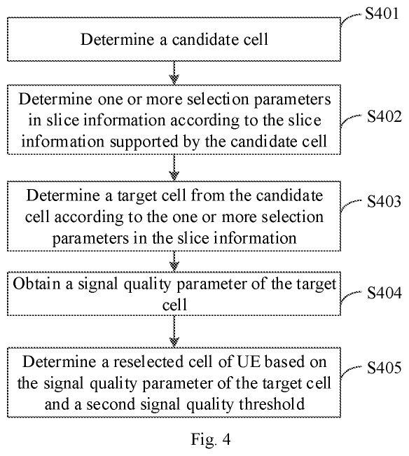

Based on the above example, FIG. 4 is a flowchart of a cell reselection method in another example of the disclosure. The method is executed by UE. As shown in FIG. 4, the method includes steps S401-S405.

In S401, a candidate cell is determined.

In S402, one or more selection parameters in slice information are determined according to the slice information supported by the candidate cell.

In S403, a target cell is determined from the candidate cell according to the one or more selection parameters in the slice information.

The steps S401 to S403 may refer to the related detailed content in any of the above example and are not described in detail here.

In S404: a signal quality parameter of the target cell is obtained.

In an implementation, a set signal quality standard existing in a cell which may normally provide a service for the UE may be understood as a situation that the cell may provide the normal service for the UE merely in a scene that signal quality of the cell meets or is higher than the standard.

Further, the signal quality standard is determined as a second signal quality parameter threshold of the cell.

In order to guarantee that the cell after reselection of the UE may normally provide the service for the UE, in the example of the disclosure, after the UE obtains the target cell, the signal quality parameter of the target cell may be compared with the second signal quality parameter threshold, and whether the target cell may be used as a reselected cell of the UE is judged based on a comparison result.

In an example, the UE may obtain the signal quality parameter of the target cell by reading attribute information of the obtained target cell.

In S405, the reselected cell of the UE is determined based on the signal quality parameter of the target cell and the second signal quality parameter threshold.

After the signal quality parameter corresponding to the target cell is determined, further judgment may be implemented based on a comparison result between the signal quality parameter of the target cell and the second signal quality parameter threshold.

In an example, the target cell is determined as the reselected cell of the UE in a case that the signal quality parameter of the target cell is greater than or equal to the second signal quality parameter threshold.

In the example of the disclosure, when the signal quality parameter of the target cell is greater than or equal to the second signal quality parameter threshold, it may be understood that in this scene, signal quality of the target cell reaches the standard for providing the normal service for the UE. Meanwhile, the target cell determined based on at least one selection parameter may maximize the support for a slice needed by the UE. Thus, the target cell may be determined as the reselected cell in which the UE resides after cell reselection.

In an example, a new target cell is reselected for the UE in a case that the signal quality parameter of the target cell is less than the second signal quality parameter threshold.

In the example of the disclosure, when the signal quality parameter of the target cell is less than the second signal quality parameter threshold, it may be understood that in this scene, signal quality of the target cell does not reach the standard for providing the normal service for the UE, and the current determined target cell may not be used as the reselected cell in which the UE resides after cell reselection.

Further, in this scene, the target cell needs to be reselected for the UE, so as to guarantee that the cell in which the UE resides after cell reselection may provide the service for the UE.

In the cell reselection method proposed by the disclosure, determining the candidate cells is implemented based on the slice-specific network configuration information or the signal quality parameter of the cell, the target cell of the UE is determined based on the selection parameter in the slice information supported by the candidate cells. Further, determining the reselected cell in which the UE resides after cell reselection is implemented based on the comparison result between the signal quality parameter of the target cell and the second signal quality parameter threshold. In the disclosure, the candidate cells are screened based on the slice-specific network configuration information or the signal quality parameter of the cell, so that the signal quality of the candidate cells is better than that of other cells of non-candidate cells. Additionally, the candidate cells are further screened by means of the slice information, so that the target cell can maximize the support for the slice that is needed by the UE. The target cell is further judged based on the second signal quality parameter threshold, so that the cell in which the UE resides after reselection can provide the better-quality differentiated service for the UE.

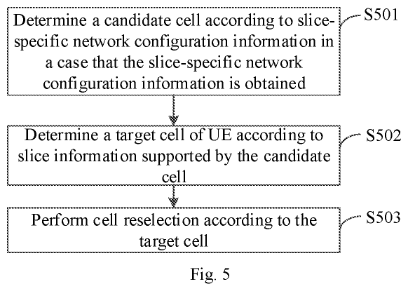

In the above example, as a possible implementation, obtaining the candidate cells may be implemented based on the obtained slice-specific network configuration information, further understanding may be achieved with reference to FIG. 5, and FIG. 5 is a schematic flowchart of a cell reselection method in another example of the disclosure. The method is executed by the UE. As shown in FIG. 5, the method includes steps S501-S503.

In S501, the candidate cell is determined according to the slice-specific network configuration information in a case that the slice-specific network configuration information is obtained.

In the example of the disclosure, the slice-specific network configuration information may include one or more configuration parameters, the configuration parameter may include, but not limited to, at least one of a slice-specific first signal quality parameter threshold, the slice-specific number N of cells or a slice-specific signal quality deviation value.

Further, determining the candidate cell may be implemented based on the obtained configuration parameter in the slice-specific network configuration information.

In an example, the configuration parameter may be the slice-specific first signal quality parameter threshold.

A cell with a signal quality parameter being greater than or equal to the slice-specific first signal quality parameter threshold is determined as the candidate cell.

In the example of the disclosure, the slice-specific first signal quality parameter thresholds of different cells being set respectively may be understood as a situation that a first signal quality parameter threshold of the same slice is configured based on different cells supporting the same slice respectively, and the first signal quality parameter thresholds corresponding to the different cells are the same or not.

The slice-specific first signal quality parameter threshold may be understood as a threshold value of a signal quality parameter needed when a cell may provide a service corresponding to a slice for the UE. Thus, the slice-specific first signal quality parameter threshold of each cell is obtained from the cells which may cover the UE, the signal quality parameter of each cell is compared with the corresponding first signal quality parameter threshold, and when the signal quality parameter of the cell is greater than or equal to the corresponding first signal quality parameter threshold, it may be understood that the signal quality of the cell may provide the service corresponding to the slice for the UE.

Further, the cell with the signal quality parameter being greater than or equal to the first signal quality parameter threshold is determined as the candidate cell.

In an example, the configuration parameter may be the number of slice-specific cells, and the number of slice-specific cells is represented by N.

A first sorting of the signal quality parameters of the cells is obtained by sorting the cells according to the signal quality parameters.

In the example of the disclosure, when the configuration parameter is the slice-specific number N of cells, it may be understood that N cells are selected from the cells covering the UE as the candidate cells of cell reselection of the UE.

In order to guarantee signal quality of the obtained candidate cells, the UE may obtain the signal quality parameters of all the cells covering the UE, sorting is performed from large to small according to the signal quality parameters, and an obtained sorting result is determined as the first sorting of the signal quality parameters of the cells.

Further, the top N cells in the first sorting are used as the candidate cells.

It may be known from the first sorting that the signal quality parameters of the top-ranking cells are superior to those of the lower-ranking cells. Thus, after the first sorting is determined, the N cells may be obtained in a sequence from top to bottom starting with the cell ranking the first in the first sorting, namely, the top N cells are obtained in the first sorting, and the N cells may be determined as the candidate cells of cell reselection of the UE.

In an example, the configuration parameter may be the slice-specific signal quality deviation value.

The signal quality parameter of the cell ranking the first in the first sorting is used as a standard signal quality parameter.

In the example of the disclosure, the signal quality of the cell may be judged based on the slice-specific signal quality deviation value. The cells covering the UE are sorted based on the signal quality parameters, and the cell with the best signal quality parameter is obtained, whose signal quality parameter is determined as the standard signal quality parameter. Further, a difference is obtained by making a subtraction between the signal quality parameters of the cells covering the UE and the standard signal quality parameter and is the signal quality deviation value. Thus, obtaining the signal quality deviation value may be implemented based on the first sorting obtained by sorting based on the signal quality parameters of the cells in the above example.

Further, a difference between the signal quality parameter of any one of the cells and the standard signal quality parameter is obtained, and in response to the difference being less than or equal to the deviation value, the candidate cell is determined.

After the standard signal quality parameter of the cell ranking the first in the first sorting is determined, a signal quality deviation value of any one of the cells based on the standard signal quality parameter is obtained by making a subtraction between the signal quality parameter of any one of the cells covering the UE and the standard signal quality parameter respectively. The signal quality deviation value is compared with the slice-specific signal quality deviation value, and determining the candidate cell is implemented based on a comparison result.

Further, cells with signal quality deviation values being less than or equal to the slice-specific signal quality deviation value are obtained and determined as the candidate cells of cell reselection of the UE. It may be understood that signal quality of the cells with the signal quality deviation values being less than or equal to the slice-specific signal quality deviation value is within a set deviation range, so that the signal quality of these cells is relatively better in all the cells covering the UE, and these cells may be determined as the candidate cells of cell reselection of the UE.

It needs to be noted that determining the candidate cell may be implemented based on any one of the above configuration parameters, or based on a plurality of the above configuration parameters, which may be selected by the UE based on actual conditions and is not limited here.

It needs to be further noted that determining the candidate cell based on the configuration parameter may have a possibility that there is no cell capable of meeting a condition corresponding to any one of the above configuration parameters in the cells covering the UE, and in this scene, in order to guarantee that the UE may obtain a cell in which the UE may reside from cell reselection, the candidate cell needs to be obtained based on other methods.

In an example, a frequency of a current cell in which the UE resides may be obtained, and in frequencies the same as the frequency, another frequency point in which determining the candidate cell may be implemented may be obtained and determined as a candidate frequency point. Further, cells under the candidate frequency point are obtained and are screened based on the above configuration parameter, and thus determining the candidate cell is implemented.

In an example, after the frequency of the current cell in which the UE resides is obtained, when the candidate frequency point is obtained in the intra-frequency the same as the frequency, there is a certain possibility that there is no candidate frequency point in which determining the candidate cell may be implemented in the intra-frequency. In this scene, in order to guarantee the quality of service provided for the UE, cells meeting the criterion S may be obtained from the current cells covering the UE based on a related mechanism, the obtained cells meeting the criterion S are sorted based on the signal quality parameters, and the cell with the best signal quality is screened out and used as the candidate cell of cell reselection of the UE.

In S502, a target cell of the UE is determined according to slice information supported by the candidate cell.

In S503, cell reselection is performed according to the target cell.

The steps S502 to S503 may refer to any of the above related detailed content and are not described in detail here.

In the cell reselection method proposed by the disclosure, in a scene that the UE obtains the slice-specific network configuration information, determining the candidate cell may be implemented based on the configuration parameter in the network configuration information, so that signal quality of the obtained candidate cell is superior to that of other cells of non-candidate cells, and thus the cell in which the UE resides after reselection may provide the better-quality differentiated service for the UE.

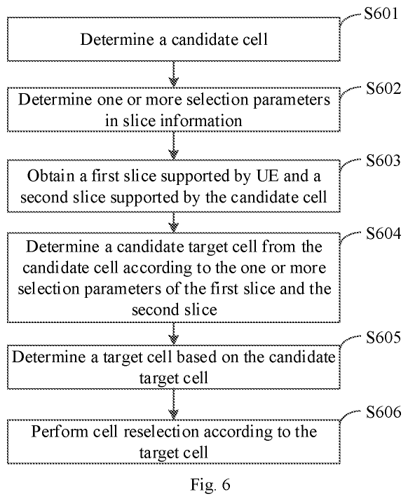

In the above example, determining the target cell may be further understood with reference to FIG. 6, and FIG. 6 is a schematic flowchart of a cell reselection method in another example of the disclosure. The method is executed by UE. As shown in FIG. 6, the method includes steps S601-S606.

In S601, a candidate cell is determined.

In S602, one or more selection parameters in slice information are determined.

The steps S601 to S602 may refer to any of the above related detailed content and are not described in detail here.

In S603, a first slice supported by the UE and a second slice supported by the candidate cell are obtained.

In order to provide the needed differentiated service for the UE, when the target cell is to be determined, determining the target cell may be implemented with reference to the first slice needed by the UE and the second slice supported by the candidate cell.

Further, the UE may obtain slice information of the first slice and slice information of the second slice included in the slice information through the slice information and then obtain the one or more selection parameters included in the slice information.

In an example, the slice information is determined by a non-access stratum (NAS) and provided for an access stratum (AS).

In S604, a candidate target cell is determined from the candidate cell according to the one or more selection parameters of the first slice and the second slice.

In the example of the disclosure, the one or more selection parameters may include the number of slices and further include a slice priority.

The number of slices may include the number of first slices, also include the number of second slices and further include the number of slices of an intersection between the first slices and the second slices.

The target cell is obtained by further screening the candidate cells based on the selection parameter.

The candidate cells are screened based on the one or more selection parameters, the number of the candidate cells obtained after screening is uncertain, thus, the candidate cells obtained by screening the candidate cells based on the one or more selection parameters may be determined as the candidate target cells, and then the target cell may be further obtained based on the candidate target cells.

In an example, the candidate cells may be screened based on the slice priority.

A first target slice with the highest priority in the first slices is obtained based on the slice priority, and candidate cells supporting the first target slice are determined as the candidate target cells.

In the example of the disclosure, the slices with the higher priorities may provide the better-quality service for the UE, thus, in order to make the obtained candidate target cells implement the support for the slice needed by the UE while guaranteeing their signal quality, the slice priorities in the first slices may be sorted, and a slice with the highest priority is obtained and determined as the first target slice.

Further, the candidate cells including the first target slice are obtained from the second slices supported by the candidate cells, and these candidate cells are candidate cells supporting the first target slice and are determined as the candidate target cells.

For example, the first slices are set as a slice1, a slice2 and a slice3. A priority relationship is: slice1>slice2>slice3, so the first target slice with the highest priority is the slice1. The current candidate cells are a cell1, a cell2 and a cell3. Slices supported by the candidate cell cell1 are the slice1 and the slice2, slices supported by the cell2 are the slice2 and the slice3, and a slice supported by the cell3 is the slice1.

Further, the candidate cells supporting the first target slice slice1 may be determined as the candidate target cells. That is, the two candidate cells cell1 and cell3 supporting the slice1 may be determined as the candidate target cells.

The cells supporting the first target slice in the candidate cells may be determined as the candidate target cells, and further screening from the candidate cells supporting the first target slice based on the priorities of all the slices in the first slices needed by the UE and supported by the candidate cells, so that determining the candidate target cells is implemented.

In an example, the first slices supported by the UE may be split based on the slice priorities, the slice with the highest priority is the first target slice, so the slice with the second-highest priority in the first slices may be determined as the second-highest target slice, the slice with the third highest priority based on the second-highest target slice is determined as the third-highest target slice, and so on.

Specifically, some candidate cells supporting the first target slice are obtained from the candidate cells based on priority splitting of the slices in the first slices, further, some candidate cells supporting the first target slice and the second-highest target slice are obtained from the some candidate cells supporting the first target slice. Further, some candidate cells supporting the first target slice, the second-highest target slice and the third-highest target slice are obtained from the some candidate cells supporting the first target splice and the second-highest target slice, and so on till candidate cells supporting a slice with the highest comprehensive priority are screened out from all the candidate cells and determined as the candidate target cells.

In an example, the candidate cells may be screened based on the number of slices.

An intersection is made between the first slices and the second slices, a second target slice with the greatest number of slices in the intersection is obtained, and candidate cells supporting the second target slice are determined as the candidate target cells.

In an implementation, the greater the number of slices supported by the candidate cells is, the wider a range of provided services is.

In the example of the disclosure, the first slices embody the slices needed by the UE, the second slices embody the slices supported by the candidate cells, in order to more accurately select the candidate target cells for the UE and meanwhile, select candidate cells as far as possible which may provide more services for the UE, an intersection process may be performed on the first slices and the second slices, and obtained slices in the intersection are the slices supported by the candidate cells and needed by the UE.

Screening the candidate target cells may be implemented by comparing the number of slices in an intersection supported by each candidate cell.

It needs to be noted that determining the candidate target cells based on at least one of the above selection parameters may be understood as a situation that the candidate target cells may be obtained from the candidate cells merely based on the slice priorities or merely based on the number of slices or based on both the slice priorities and the number of slices, which is not limited here.

Further, in a case that the candidate target cells of the UE are obtained from the candidate cells based on both the slice priorities and the number of slices, the candidate target cells may be determined by obtaining the slice priorities and then based on the number of slices, or the candidate target cells may also be determined based on a comparison of the number of slices and then based on the slice priorities.

Specifically, candidate cells B supporting the highest-priority slice may be obtained from candidate cells A, intersection processing is performed between slices supported by some candidate cells B and the first slices needed by the UE. Further, candidate cells C supporting slices in the intersection are obtained from the candidate cells B, the number of slices in the intersection supported by the candidate cells C is compared, and candidate cells D supporting the greatest number of slices in the intersection are obtained and determined as the candidate target cells.

Alternatively, an intersection is made between the second slices supported by the candidate cells A and the first slices needed by the UE, candidate cells E supporting slices in the intersection are obtained from the candidate cells A, the number of the slices in the intersection supported by the candidate cells E is compared, and candidate cells F supporting the greatest number of slices in the intersection are selected. Further, the priorities of the slices in the intersection supported by the candidate cells F are obtained, and the candidate target cells are determined based on the priorities.

In an example, candidate cells G supporting the first target slice may be obtained from the candidate cells F and determined as the candidate target cells.

In an example, the candidate cells G supporting the first target slice may be obtained from the candidate cells F, further, candidate cells H supporting the second-highest target slice are obtained from the candidate cells G, further, candidate cells I supporting the third-highest target slice are obtained from the candidate cells H, and so on till the candidate cells supporting a slice combination with the highest comprehensive priority are obtained and determined as the candidate target cells.

In an example, a total priority of the slices supported by each candidate cell in the candidate cells F may be compared, and candidate cells J supporting the slices with the highest total priority in the candidate cells F are obtained and determined as the candidate target cells.

The candidate cells J may support the highest-priority slice or not, which is not limited here.

In S605, the target cell is determined based on the candidate target cells.

Selecting the target cell may be implemented from the candidate target cells after the candidate target cells of the UE are obtained. After selecting the candidate target cells is implemented from the candidate cells based on the one or more selection parameters, the number of the obtained candidate target cells is uncertain, thus, in order to guarantee that the best target cell may be obtained, different processing needs to be performed on the candidate target cells respectively based on different numbers, and thus the target cell may be determined in a scene of different numbers of candidate target cells.

The number of the determined target cells is 1.

In an implementation, the number of the obtained candidate target cells may be 1, or be greater than 1 or be 0.

As a possible scene, if the number of the candidate target cells is 1, the candidate target cell is determined as the target cell.

In the example of the disclosure, when the number of the obtained candidate target cells is 1, in this scene, the obtained candidate target cell is a unique candidate item of the target cell and meets a condition corresponding to at least one selection parameter, and thus, the obtained one candidate target cell may be determined as the target cell of cell reselection of the UE.

As another possible scene, if the number of the candidate target cells is greater than 1, the target cell is determined based on the signal quality parameters of the candidate target cells.

In the example of the disclosure, when the number of the obtained candidate target cells is greater than 1, it may be understood that there are a plurality of cells capable of meeting a condition corresponding to at least one selection parameter, and further, the candidate target cells with the number being greater than 1 may be further screened.

Further, priorities of frequencies to which the candidate target cells belong may be obtained and compared with a priority of a frequency of a current cell in which the UE resides, and the target cell may be determined based on a comparison result.

In an example, when the obtained priorities of the frequencies to which the candidate target cells belong and the priority of the frequency of the current cell in which the UE resides belong to the same priority in the intra-frequency and/or inter-frequency and the frequencies of the candidate target cells and the frequency of the current cell to which the UE belongs belong to the same priority in the intra-frequency and/or inter-frequency, a second sorting of the signal quality parameters of the candidate target cells is obtained by sorting the candidate target cells based on the signal quality parameters, and the candidate target cell ranking the first is selected from the second sorting and determined as the target cell.

In the example of the disclosure, in a scene that the priorities of the frequencies to which the candidate target cells belong and the priority of the frequency of the current cell in which the UE resides belong to the same priority in the intra-frequency and/or inter-frequency, the candidate target cells may be screened based on signal quality of the candidate target cells.

Further, the signal quality parameters of the candidate target cells are obtained, the candidate target cells are sorted based on the signal quality parameters, and an obtained sorting result is determined as the second sorting. The candidate target cell with the best signal quality in all the candidate target cells may be obtained from the second sorting, which may be understood as a situation that the candidate target cell ranking the first is obtained from the second sorting, the candidate target cell is the first candidate target cell in the second sorting, and determined as the target cell of cell reselection of the UE in this scene.

In an example, when the obtained priorities of the frequencies to which the candidate target cells belong and the priority of the frequency of the current cell in which the UE resides belong to different priorities in the intra-frequency and/or inter-frequency and the frequencies of the candidate target cells and the frequency of the current cell to which the UE belongs belong to different priorities in the intra-frequency and/or inter-frequency, a second sorting of the signal quality parameters of the candidate target cells is obtained by sorting the candidate target cells based on the signal quality parameters, and the candidate target cell ranking the first and with the highest frequency priority is selected from the second sorting and determined as the target cell.

In the example of the disclosure, in a scene that the priorities of the frequencies to which the candidate target cells belong and the priority of the frequency of the current cell in which the UE resides belong to different priorities in the intra-frequency and/or inter-frequency, the candidate target cells may be screened based on the signal quality parameters of the candidate target cells and the priorities of the frequencies to which the candidate target cells belong.

Further, the signal quality parameters of the candidate target cells may be obtained, the candidate target cells are sorted based on the signal quality parameters, and like the above example, an obtained sorting result may be determined as the second sorting. Based on the second sorting, the candidate target cell with the best signal quality may be obtained based on the current scene, a priority of a frequency to which the candidate target cell with the best signal quality belongs is obtained, and then determining the target cell is implemented.

It may be understood that the candidate target cell with the best signal quality parameter in the current scene is obtained, the priority of the frequency to which the candidate target cell belongs and the priority of the frequency of the current cell in which the UE resides are compared, and if the priority of the frequency to which the candidate target cell belongs is superior to the priority of the frequency of the current cell in which the UE resides, the candidate target cell is determined as the target cell of cell reselection of the UE.

For example, the frequency of the current cell in which the UE resides and the frequency to which the candidate target cell belongs belong to the inter-frequency and the priorities are different, the candidate target cell with the best signal quality parameter and the highest frequency priority in the candidate target cells may be obtained and determined as the target cell.

For another example, the current cell in which the UE resides and the candidate target cell are inter-RAT cells, so the candidate target cell with the best signal quality parameter and the highest frequency priority in the candidate target cells may be obtained and determined as the target cell.

As yet another possible scene, if the number of the candidate target cells is 0, the target cell is determined based on the signal quality parameters of the cells.

In the example of the disclosure, a candidate target cell which does not meet a condition corresponding to any one selection parameter may exist in the candidate cells, so in a case that the number of the candidate target cells is 0, the target cell may be determined through other means.

In order to guarantee that the cell in which the UE resides after cell reselection may provide the better-quality service for the UE as far as possible, the target cell may be determined for the UE through the signal quality parameters.

In an example, screening may be performed from the cells covering the UE, a third sorting of the signal quality parameters of the cells is obtained based on an existing mechanism and the signal quality parameter of the cells, and the cell ranking the first in the third sorting is determined as the target cell.

In the example of the disclosure, the signal quality parameters of the cells covering the UE may be sorted based on the existing mechanism, and a sorting result is determined as the third sorting. Based on the third sorting, the cell with the best signal quality parameter may be selected from the cells covering the UE and may be further determined as the target cell of the UE.

It may be understood that the cell ranking the first in the third sorting is determined as the target cell of the UE.

In an example, screening may be performed from the candidate cells, a fourth sorting of the signal quality parameters of the candidate cells is obtained based on the signal quality parameters of the candidate cells, and the candidate cell ranking the first in the fourth sorting from the candidate cells is determined as the target cell.

In the example of the disclosure, the target cell may be reselected for the UE from the candidate cells, the candidate cells may be sorted based on the signal quality parameters, and a sorting result is determined as the fourth sorting.

Further, obtaining the candidate cell with the best signal quality parameter in the fourth sorting may be understood as determining the candidate cell ranking the first in the fourth sorting as the target cell of the UE.

In order to enable the UE to obtain the cell in which the UE may reside after cell reselection and enable the cell in which the UE resides to provide the better-quality service for the UE, in a scene that the candidate target cells cannot be obtained based on the selection parameter, the cells covering the UE or the candidate cells of the UE need to be screened again based on the signal quality parameters, and thus the cell with the best signal quality is obtained and used as the target cell of the UE.

In S606, cell reselection is performed according to the target cell.

The step S606 may refer to any of the above related detailed content and is not described in detail here.

In the cell reselection method proposed by the disclosure, the candidate target cells may be obtained from the candidate cells based on the one or more selection parameters of the slices, determining the target cell is implemented respectively based on a scene of different numbers of the candidate target cells, so that the target cells may maximize the support for the slice needed by the UE, and thus the cell in which the UE resides after reselection may provide the better-quality differentiated service for the UE.

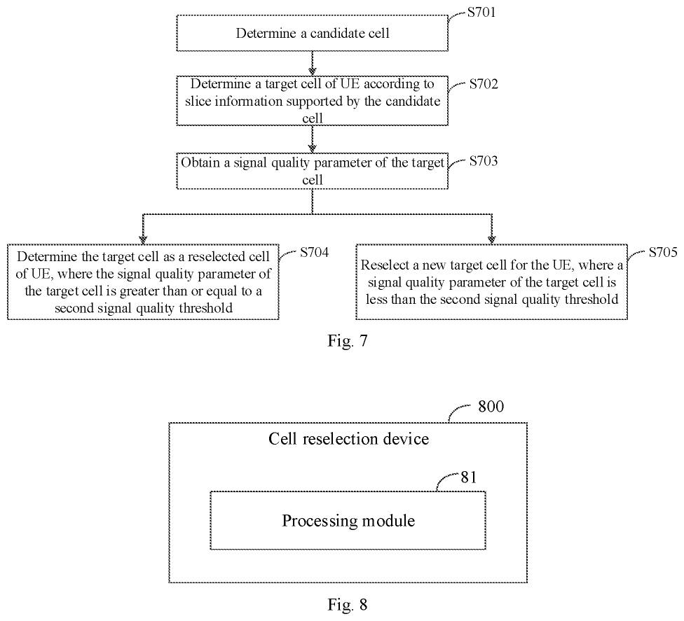

In the above example, a reselected cell in which the UE resides after cell reselection may be determined based on the determined target cell, which may be further understood with reference to FIG. 7, and FIG. 7 is a schematic flowchart of a cell reselection method in another example of the disclosure. The method is executed by UE. As shown in FIG. 7, the method includes steps S701-S705.

In S701, a candidate cell is determined.

In S702, a target cell of the UE is determined according to slice information supported by the candidate cell.

The steps S701 to S702 may refer to any of the above related detailed content and are not described in detail here.

In S703, a signal quality parameter of the target cell is obtained.

In an implementation, the target cell determined based on above related parameters is obtained by screening merely within a range of some cells, and there is a possibility that the determined target cell cannot normally provide the service for the UE, so in order to guarantee that the cell in which the UE resides after cell reselection may provide the good-quality differentiated service for the UE, after the target cell is determined, the target cell may be further processed based on a set condition, so as to determine the reselected cell in which the UE may reside after reselection.

Further, the target cells may be screened based on the signal quality parameters, and the set condition may be determined as a second signal quality parameter threshold of the cells.

A signal quality parameter of the current obtained target cell is compared with the second signal quality parameter threshold, and the target cell is judged based on a comparison result.

In an example, the signal quality parameter of the target cell may be greater than or equal to the second signal quality parameter threshold.

In S704, the target cell is determined as a reselected cell of the UE, where the signal quality parameter of the target cell is greater than or equal to the second signal quality parameter threshold.

In the example of the disclosure, when the signal quality parameter of the obtained target cell is greater than or equal to the second signal quality parameter threshold, it may be understood that signal quality of the current obtained target cell may provide the good-quality service for the UE.

Further, a signal of the target cell obtained through the above method is better in the cells covering the UE, the target cell may support the slice needed by the UE, and thus, the current obtained target cell may be determined as the reselected cell in which the UE resides after cell reselection. In other words, the obtained target cell has a superior signal quality.

Alternatively, the signal quality parameter of the target cell may be smaller than the second signal quality parameter threshold.

In this case, step S705 is performed. In S705, a new target cell is reselected for the UE, where a signal quality parameter of the target cell is less than the second signal quality parameter threshold.

In the example of the disclosure, the second signal quality parameter threshold may be understood as a threshold value of a signal quality parameter of the target cell that may normally provide the service for the UE. The signal quality parameter of the current target cell being less than the second signal quality parameter threshold may be understood as a situation that the signal quality parameter of the current obtained target cell cannot provide the normal service for the UE.

Further, though the current obtained target cell is a better cell in the cells covering the UE, it does not reach the standard for providing the service for the UE, so the current obtained target cell cannot be used as the reselected cell in which the UE resides after cell reselection. Further, the target cell needs to be reselected for the UE.

A fifth sorting is obtained by sorting the candidate cells based on the signal quality parameters.

Specifically, as the signal quality parameter of the current determined target cell is less than the second signal quality parameter threshold and the target cell is determined based on the candidate cells, the signal quality parameter of each cell in the candidate cells needs to be judged, and the new target cell is reselected for the UE by different methods based on a judgment result of the signal quality parameters of all the candidate cells. Further, the UE may sort all the candidate cells based on the signal quality parameters of the obtained candidate cells and determine a sorting result as the fifth sorting.

In an example, when the signal quality parameter of the target cell is less than the second signal quality parameter threshold and ranks the first in the fifth sorting, selecting any intra-frequency cell of the target cells as the target cell is skipped within a set time.

Specifically, the current obtained target cell ranking the first in the fifth sorting may be understood as a situation that the signal quality parameter of the current obtained target cell is the best in all the candidate cells, further, the signal quality parameter of the current obtained target cell does not reach the standard corresponding to the second signal quality parameter threshold, and thus it may be known that the signal quality parameters of all the candidate cells corresponding to the current target cell are less than the second signal quality parameter threshold.

Further, in order to make the cell in which the UE resides after reselection be better than the current cell in which the UE resides, any intra-frequency cell of the current obtained target cell is not used as the target cell.

A judgment of skipping selecting any intra-frequency cell of the target cells as the target cell has a set time, for example, 300 seconds. Selecting any intra-frequency cell of the target cells as the target cell is skipped within a set time range.

In an example, when the signal quality parameter of the target cell is less than the second signal quality parameter threshold and does not rank the first in the fifth sorting, the candidate cell ranking the first in the fifth sorting in the candidate cells is determined as the new target cell of the UE. Specifically, if the signal quality parameter of the current obtained target cell is less than the second signal quality parameter threshold and does not rank the first in the fifth sorting, the candidate cell ranking the first in the fifth sorting may be further judged.

As the signal quality parameter of the candidate cell ranking the first in the fifth sorting is greater than the signal quality parameter of the current obtained target cell, the signal quality parameter of the candidate cell ranking the first in the fifth sorting may be compared with the second signal quality parameter threshold, and the new target cell is selected for the UE based on a comparison result.

Further, the candidate cell ranking the first in the fifth sorting may be used as the new target cell, and a signal quality parameter of the new target cell may be compared with the second signal quality parameter threshold.

As a possible result, when the signal quality parameter of the target cell is greater than or equal to the second signal quality parameter threshold, the target cell is determined as the new target cell of the UE.

It may be understood that when the signal quality parameter of the new target cell is greater than the second signal quality parameter threshold, the signal quality parameter of the new target cell reaches the standard for providing the normal service for the UE, and thus, the candidate cell may be determined as the new target cell of the UE.

The new target cell is the reselected cell in which the UE resides after reselection.

As another possible result, when the signal quality parameter of the target cell is less than the second signal quality parameter threshold, selecting any intra-frequency cell of the target cells as the target cell is skipped within a set time.

It may be understood that the signal quality parameter of the new target cell ranking the first in the fifth sorting is less than the second signal quality parameter threshold, all the candidate cells in the fifth sorting cannot reach the standard for providing the normal service for the UE, and thus, in order to guarantee that the cell in which the UE resides after reselection may provide the better-quality service for the UE, any cell in the intra-frequency with the new target cell is not used as the candidate cell of cell reselection of the UE within the set time range.

In the cell reselection method proposed by the disclosure, the determined target cell is further judged, different coping methods are proposed respectively according to possible different cases of the signal quality parameters of the target cells, and thus the cell in which the UE resides after reselection may provide the better-quality differentiated service for the UE.

In the above example proposed by the disclosure, the method proposed by the example of the disclosure is introduced in perspectives of a network device and a terminal device. In order to implement the various functions in the above method proposed by the example of the disclosure, the network device and the terminal device may include a hardware structure and a software module, and the above various functions are implemented in a form of the hardware structure, the software module or the hardware structure combined with the software module. A certain function in the above various functions may be executed in a form of the hardware structure, the software module, or the hardware structure combined with the software module.

FIG. 8 is a schematic structural diagram of a cell reselection device 800 in an example of the disclosure. As shown in FIG. 8, the cell reselection device 800 may include: a processing module 81 and a transceiving module 82.

The transceiving module 82 may include a sending module and/or a receiving module, the sending module is configured to implement a sending function, the receiving module is configured to implement a receiving function, and the transceiving module 82 may implement the sending function and/or the receiving function.

The cell reselection device 800 may be a terminal device.

The processing module 81 is configured to determine a candidate cell; determine a target cell of UE according to slice information supported by the candidate cell; and perform cell reselection according to the target cell.

The processing module 81 is further configured to determine the candidate cell according to slice-specific network configuration information in a case that the slice-specific network configuration information is obtained; or determine the candidate cell based on a signal quality parameter of a cell in a case that the slice-specific network configuration information is not obtained.

Additionally, the processing module 81 is further configured to use a cell meeting one or more configuration parameters at the same time as the candidate cell.

In the cell reselection device 800, the configuration parameter includes at least one of a slice-specific first signal quality parameter threshold, the slice-specific number N of cells or a slice-specific signal quality deviation value, where the configuration parameter can be configured for at least one slice or at least one slice group.

The processing module 81 is further configured to: determine a cell with a signal quality parameter being greater than or equal to the slice-specific first signal quality parameter threshold as the candidate cell. As well as,

configure first signal quality parameter thresholds for the same slice respectively based on different cells supporting the same slice, where the first signal quality parameter thresholds corresponding to the different cells are the same or not.

The processing module 81 is further configured to obtain a first sorting of signal quality parameters of cells by sorting cells according to the signal quality parameters; and use top N cells in the first sorting as the candidate cells. Additionally, the processing module 81 is further configured to determine a standard signal quality parameter of a cell ranking the first in the first sorting; and obtain a difference between a signal quality parameter of any cell and the standard signal quality parameter, and determine the candidate cell in response to the difference being less than or equal to the deviation value.

In the cell reselection device 800, the slice-specific network configuration information is carried by a broadcast system message and/or dedicated signaling.

The processing module 81 is further configured to determine one or more selection parameters in the slice information; and determine a target cell from the candidate cell according to the one or more selection parameters.

In the cell reselection device 800, the slice information supported by the candidate cell is carried by a broadcast system message and/or dedicated signaling.

The processing module 81 is further configured to obtain a first slice supported by the UE and a second slice supported by the candidate cell; and determine the target cell from the candidate cell based on one or more selection parameters of the first slice and the second slice.

In the cell reselection device 800, the selection parameter includes a slice priority and/or the number of slices.

The processing module 81 is further configured to obtain a first target slice with the highest priority in the first slice based on the slice priority, and determine a candidate cell supporting the first target slice as a candidate target cell; or intersect the first slice and the second slice, obtain second target slices with the greatest number of slices in the intersection, and determine the candidate cell supporting the second target slices as a candidate target cell; and determine the target cell based on the candidate target cell.

The processing module 81 is further configured to determine the candidate target cell as the target cell in a case that the number of the candidate target cells is 1; or determine the target cell based on signal quality parameters of the candidate target cells in a case that the number of the candidate target cells is greater than 1; or determine the target cell based on a signal quality parameter of a cell in a case that the number of the candidate target cells is 0.

The processing module 81 is further configured to obtain a second sorting of the signal quality parameters of the candidate target cells by sorting the candidate target cells based on the signal quality parameters in a case that a frequency of the candidate target cells and a frequency of a current cell to which the UE belongs belong to the same priority in the intra-frequency and/or inter-frequency, and select and determine the cell ranking the first in the candidate target cells from the second sorting as the target cell; or obtain a second sorting of the signal quality parameters of the candidate target cells by sorting the candidate target cells based on the signal quality parameters in a case that the frequency of the candidate target cells and the frequency of the current cell to which the UE belongs belong to different priorities in the intra-frequency and/or inter-frequency, and select and determine the cell ranking the first and with the highest frequency priority in the candidate target cells from the second sorting as the target cell.

The processing module 81 is further configured to obtain a third sorting of the signal quality parameter of the cell based on an existing mechanism and the signal quality parameter of the cell, and determine a cell ranking the first in the third sorting as the target cell; or obtain a fourth sorting of the signal quality parameters of the candidate cells based on the signal quality parameters of the candidate cells, and determine a candidate cell ranking the first in the fourth sorting from the candidate cells as the target cell.

The processing module 81 is further configured to obtain a signal quality parameter of the target cell; and determine the target cell as a reselected cell of the UE, where the signal quality parameter of the target cell is greater than or equal to a second signal quality parameter threshold.

The processing module 81 is further configured to reselect a new target cell for the UE, where a signal quality parameter of the target cell is less than the second signal quality parameter threshold.

The processing module 81 is further configured to obtain a fifth sorting by sorting the candidate cells based on the signal quality parameters; and skip selecting any intra-frequency cell of the target cell as the target cell within a set time in a case that the signal quality parameter of the target cell is less than a second signal quality parameter threshold and the signal quality parameter of the target cell ranks the first in the fifth sorting.

The processing module 81 is further configured to determine the candidate cell ranking the first in a fifth sorting in the candidate cells as the new target cell of the UE in a case that the signal quality parameter of the target cell is less than the second signal quality parameter threshold and the signal quality parameter of the target cell does not rank the first in the fifth sorting; determine the target cell as the new target cell of the UE in a case that the signal quality parameter of the target cell is greater than or equal to the second signal quality parameter threshold; or skip selecting any intra-frequency cell of the target cell as the target cell within the set time in a case that the signal quality parameter of the target cell is less than the second signal quality parameter threshold.

In the cell reselection device proposed by the disclosure, determining the candidate cells is implemented based on the slice-specific network configuration information or the signal quality parameter of the cell, the target cell of the UE is determined based on the selection parameter in the slice information supported by the candidate cells. Further, determining the reselected cell in which the UE resides after cell reselection is implemented based on a comparison result between the signal quality parameter of the target cell and the second signal quality parameter threshold. In the disclosure, the candidate cells are screened based on the slice-specific network configuration information or the signal quality parameter of the cell, so that the signal quality of the candidate cells is superior to that of other cells of non-candidate cells. The candidate cells are further screened by means of the slice information, so that the target cell can maximize the support for a slice that is needed by the UE, and the target cell is further judged based on the second signal quality parameter threshold, so that the cell in which the UE resides after reselection can provide a better-quality differentiated service for the UE.

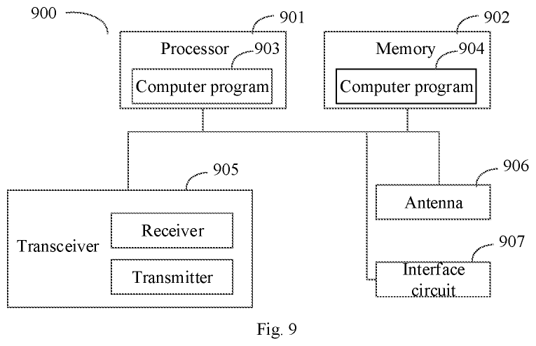

FIG. 9 is a schematic structural diagram of a communication device 900 in an example of the disclosure. The communication device 900 may be a network device or a terminal device, may also be a chip, a chip system, a processor or the like supporting the network device to implement the above method, and may also be a chip, a chip system, a processor or the like supporting the terminal device to implement the above method. The device may be configured to implement the method described in the above method example, which may specifically refer to the description in any method example described herein.

The communication device 900 may include one or more processors 901. The processor 901 may be a general-purpose processor, a special-purpose processor or the like. For example, the processor may be a baseband processor or a central processing unit. The baseband processor may be configured to process a communication protocol and communication data, the central processing unit may be configured to control the communication device (such as a base station, a baseband chip, a terminal device, a terminal device chip, a DU, a CU or the like) to execute a computer program and process data of the computer program.

In an example, the communication device 900 may further include one or more memories 902 which may store a computer program 904, and the processor 901 executes the computer program 904 so as to cause the communication device 900 to execute the method described in the above method example. In an example, the memory 902 may further store data. The communication device 900 and the memory 902 may be independently arranged or integrated.

In an example, the communication device 900 may further include a transceiver 905 and an antenna 906. The transceiver 905 may be called a transceiving unit, a transmitter receiver, a transceiver circuit or the like and is configured to implement a transceiving function. The transceiver 905 may include a receiver and a transmitter, the receiver may be called a receiving machine, a receiving circuit or the like and configured to implement a receiving function; and the transmitter may be called a transmitting machine or a transmission circuit and configured to implement a sending function.

In an example, the communication device 900 may further include one or more interface circuits 907. The interface circuit 907 is configured to receive a code instruction and transmit the code instruction to the processor 901. The processor 901 runs the code instruction so as to cause the communication device 900 to execute the method described in the method example.

The communication device 900 is the terminal device, and the processor 901 is configured to execute steps in FIG. 2, FIG. 3 and FIG. 4.

In an implementation, the processor 901 may include a transceiver (not shown) configured to implement receiving and sending functions. For example, the transceiver may be a transceiver circuit, an interface or an interface circuit. The transceiver circuit, the interface or the interface circuit configured to implement the receiving and sending functions may be separated or integrated. The transceiver circuit, interface or interface circuit may be configured to read and write code/data, or the transceiver circuit, interface or interface circuit may be configured to transmit or transfer a signal.

In an implementation, the processor 901 may store a computer program 903, and the computer program 903 runs on the processor 901 so as to cause the communication device 900 to execute the method described in the above method example. The computer program 903 may be firmed in the processor 901, and in this case, the processor 901 may be implemented by hardware.

In an implementation, the communication device 900 may include a circuit, and the circuit may implement the sending, receiving or communication functions in the above method example. The processor and the transceiver described in the disclosure may be implemented on an integrated circuit (IC), an analog IC, a radio frequency integrated circuit (RFIC), a mixed signal IC, an application specific integrated circuit (ASIC), a printed circuit board (PCB), an electronic device or the like. The processor and the transceiver may also be manufactured by various IC technologies, for example, a complementary metal oxide semiconductor (CMOS), an nMetal-oxide-semiconductor (NMOS), a positive channel metal oxide semiconductor (PMOS), a bipolar junction transistor (BJT), a bipolar CMOS (BiCMOS), a silicon germanium (SiGe), gallium arsenide (GaAs) or the like.

The communication device described in the above example may be the network device or the terminal device (such as a first terminal device in the above method example), but a range of the communication device described in the disclosure is not limited to this, and a structure of the communication device may be not limited by FIG. 9. The communication device may be an independent device or a part of a larger device. For example, the communication device may be: (1) an independent integrated circuit (IC), chip, chip system or sub-system; (2) a set with one or more ICs, in an example, the IC set may also include a storage component configured to store data and a computer program; (3) the ASIC, for example, a modem; (4) a module capable of being embedded into another device; (5) a receiver, a terminal device, a smart terminal device, a cell phone, a wireless device, a handset, a mobile unit, a vehicle-mounted device, a network device, a cloud device, an artificial intelligence device or the like; and (6) others.

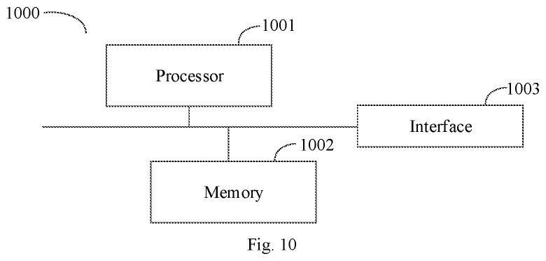

A case that the communication device may be the chip or the chip system may refer to a schematic structural diagram of a chip shown in FIG. 10. The chip 1000 shown in FIG. 10 includes a processor 1001, an interface 1002, and a memory 1003. There may be one or more processors 1001, a plurality of interfaces 1002, and one or more memories 1003.

In a case that the chip 1000 is configured to implement the functions of the terminal device in the example of the disclosure, the interface 1002 is configured to execute steps in FIG. 2, FIG. 3, FIG. 4 and FIG. 5.

In an example, the memory 1003 is configured to store necessary computer programs and data.

Those skilled in the art may also know that various illustrative logical blocks and steps listed in the example of the disclosure may be implemented by electronic hardware, computer software or combining the both. Whether such functions are implemented by the hardware or the software depends on a specific application and a design demand of a whole system. Those skilled in the art may use various methods for implementing functions for each specific application, but such implementation is not construed as being beyond the protection scope of the example of the disclosure.

An example of the disclosure further provides a cell reselection system. The system includes a communication device as a terminal device (such as the terminal device described herein with respect to the included method examples) and a communication device as a network device in the above example of FIG. 9, or the system includes a communication device as a terminal device (such as the terminal device described herein with respect to the included method examples) and a communication device as a network device in the example of FIG. 10.

The disclosure further provides a non-transitory computer-readable storage medium, storing an instruction, and the instruction, when executed by a computer, implements functions in any above method example.

The disclosure further provides a computer program product, where the computer program product, when executed by a computer, implements functions in any above method example.

The above example may be implemented entirely or partially through software, hardware, firmware or any combination of them. An implementation by the software may be entirely or partially in a form of a computer program product. The computer program product includes one or more computer programs. When the computer programs are loaded and executed on the computer, flows or functions according to the example of the disclosure are entirely or partly generated. The computer may be a general-purpose computer, a special-purpose computer, a computer network, or other programmable devices. The computer program may be stored in a computer-readable storage medium, or transmitted from one computer-readable storage medium to another computer-readable storage medium, for example, the computer program may be transmitted from one website, computer, server or data center to another website, computer, server or data center in a wired (for example, a coaxial cable, an optical fiber, a digital subscriber line (DSL)) or wireless (for example, infrared, wireless, microwave or the like). The computer-readable storage medium may be any available medium that the computer can access, or a server, a data center and another data storage devices including one or more available media integrated. The available medium may be a magnetic medium (for example, a floppy disk, a hard disk and a magnetic tape), an optical medium (for example, a high-density digital video disc (DVD)), or a semiconductor medium (for example, a solid state disk (SSD)), or the like.

Those ordinarily skilled in the art may know that various ordinal numerals such as first and second involved in the disclosure are distinguished for convenient description but are not used for limiting the scope of the examples of the disclosure and also represent a sequential order.

At least one in the disclosure may also be described as one or a plurality, and the plurality may be two, three, four or more, which is not limited in the disclosure. In the example of the disclosure, as for a technical feature, technical features on this technical feature are distinguished through “first”, “second”, “third”, “A”, “B”, “C”, “D” and the like, and there is no sequential order or magnitude sequence between the technical features described by “first”, “second”, “third”, “A”, “B”, “C” and “D”.

A corresponding relationship shown in each table in the disclosure may be configured or pre-defined. Values of information in each table are merely example and may be set as other values, which is not limited in the disclosure. During configuring the corresponding relationship between the information and the various parameters, all the corresponding relationships shown in each table are not necessarily configured. For example, in the tables in the disclosure, the corresponding relationships shown in some rows may also be not configured. For another example, a proper variation may be made based on the above tables, for example, splitting, merging and the like. Names of parameters shown in titles in each table may also use other names comprehensible for the communication device, and values or representation forms of the parameters may also be other values or representation forms comprehensible for the communication device. In an implementation of each above table, other data structures may also be used, for example, an array, a queue, a container, a stack, a linear table, a pointer, a chain table, a tree, a graph, a structural body, a class, a heap, a hash table, or the like may be used.

Pre-defining in the disclosure may be understood as defining, pre-defining, storage, pre-storage, pre-consulting, pre-configuration, firming or pre-flash.

Those ordinarily skilled in the art may be aware that units and algorithm steps of the various examples described with reference to the examples disclosed here can be implemented by electronic hardware or combining computer software and the electronic hardware. Whether these functions are executed in a form of the hardware or a form of the software depends on particular applications and design constraint conditions of the technical solutions. Professional and technical staff may use different methods for implementing the described functions for each particular application, but this implementation is not to be regarded as departing from the scope of this application.

Those skilled in the art may clearly know that for convenient and concise description, specific working processes of the above described system, device and units may refer to corresponding processes in the above method example, which is not repeated here.

The above is merely specific implementations of the disclosure, but the protection scope of the disclosure is not limited to this, any of those skilled in the art may easily figure out variations or replacements within the technical scope disclosed by the disclosure, and the variations and the replacements are supposed to be covered within the protection scope of the disclosure. Thus, the protection scope of the disclosure is supposed to be subject to the protection scope of the claims.

Examples of the disclosure provide a cell reselection method and device thereof, which may be used for solving a problem of improving channel estimation accuracy in the related art.

In a first aspect, an example of the disclosure provides a cell reselection method, including: determining a candidate cell; determining a target cell of UE according to slice information supported by the candidate cell; and performing cell reselection according to the target cell.

The cell reselection method provided by the first aspect of the disclosure may also have the following technical features: in an implementation, determining the candidate cell includes: determining the candidate cell according to slice-specific network configuration information in a case that the slice-specific network configuration information is obtained; or determining the candidate cell based on a signal quality parameter of a cell in a case that the slice-specific network configuration information is not obtained.

In an implementation, the network configuration information includes one or more configuration parameters, and determining the candidate cell according to the slice-specific network configuration information includes: using a cell meeting the one or more configuration parameters at the same time as the candidate cell.

In an implementation, the configuration parameter includes at least one of a slice-specific first signal quality parameter threshold, a number of slice-specific cells N or a slice-specific signal quality deviation value, where the configuration parameter can be configured for at least one slice or at least one slice group.

In an implementation, the network configuration information includes a slice-specific first signal quality parameter threshold, where determining the candidate cell according to the slice-specific network configuration information includes: determining a cell with a signal quality parameter being greater than or equal to the slice-specific first signal quality parameter threshold as the candidate cell.

In an implementation, the method further including: configuring first signal quality parameter thresholds for the same slice respectively based on different cells supporting the same slice, where the first signal quality parameter thresholds corresponding to the different cells are the same or not.

In an implementation, the network configuration information includes the number N of cells, and determining the candidate cell according to the slice-specific network configuration information includes: obtaining a first sorting of the signal quality parameters of cells by sorting the cells according to signal quality parameters; and using top N cells in the first sorting as the candidate cells.

In an implementation, the network configuration information includes a slice-specific signal quality deviation value, and determining the candidate cell according to the slice-specific network configuration information includes: determining a standard signal quality parameter of a cell ranking the first in the first sorting; and obtaining a difference between a signal quality parameter of any cell and the standard signal quality parameter, and determining the candidate cell in response to the difference being less than or equal to the deviation value.

In an implementation, the slice-specific network configuration information is carried by a broadcast system message and/or dedicated signaling.

In an implementation, determining the target cell of the UE according to the slice information supported by the candidate cell includes: determining one or more selection parameters in the slice information; and determining the target cell from the candidate cell according to the one or more selection parameters.

In an implementation, the slice information supported by the candidate cell is carried by a broadcast system message and/or dedicated signaling.

In an implementation, determining the target cell from the candidate cell according to the one or more selection parameters includes: obtaining a first slice supported by the UE and a second slice supported by the candidate cell; and determining the target cell from the candidate cell based on one or more selection parameters of the first slice and the second slice.

In an implementation, the selection parameter includes a slice priority and/or the number of slices.

In an implementation, determining the target cell from the candidate cell based on the one or more selection parameters of the first slice and the second slice includes: obtaining a first target slice with the highest priority in the first slice based on the slice priority, and determining a candidate cell supporting the first target slice as a candidate target cell; or intersecting the first slice and the second slice, obtaining second target slices with the greatest number of slices in the intersection, and determining the candidate cell supporting the second target slices as a candidate target cell; and determining the target cell based on the candidate target cell.

In an implementation, determining the target cell based on the candidate target cell includes: determining the candidate target cell as the target cell in a case that the number of candidate target cells is 1; or determining the target cell based on signal quality parameters of the candidate target cells in a case that the number of candidate target cells is greater than 1; or determining the target cell based on a signal quality parameter of a cell in a case that the number of candidate target cells is 0.

In an implementation, determining the target cell based on the signal quality parameters of the candidate target cells in a case that the number of candidate target cells is greater than 1 includes: obtaining a second sorting of the signal quality parameters of the candidate target cells by sorting the candidate target cells based on the signal quality parameters in a case that a frequency of the candidate target cells and a frequency of a current cell to which the UE belongs belong to the same priority in an intra-frequency and/or inter-frequency, and selecting and determining the candidate target cell ranking the first from the second sorting as the target cell; or obtaining a second sorting of the signal quality parameters of the candidate target cells by sorting the candidate target cells based on the signal quality parameters in a case that the frequency of the candidate target cells and the frequency of the current cell to which the UE belongs belong to different priorities in the intra-frequency and/or inter-frequency, and selecting and determining the candidate target cell ranking the first and with the highest frequency priority from the second sorting as the target cell.

In an implementation, determining the target cell based on the signal quality parameter of the cell in a case that the number of candidate target cells is 0 includes: obtaining a third sorting of the signal quality parameter of the cell based on an existing mechanism and the signal quality parameter of the cell, and determining a cell ranking the first in the third sorting as the target cell; or obtaining a fourth sorting of the signal quality parameters of the candidate cells based on the signal quality parameters of the candidate cells, and determining a candidate cell ranking the first in the fourth sorting from the candidate cells as the target cell.

In an implementation, the method further including: obtaining a signal quality parameter of the target cell; and determining the target cell as a reselected cell of the UE, where the signal quality parameter of the target cell is greater than or equal to a second signal quality parameter threshold.

In an implementation, the method further including: reselecting a new target cell for the UE, where a signal quality parameter of the target cell is less than the second signal quality parameter threshold.

In an implementation, reselecting the new target cell for the UE includes: obtaining a fifth sorting by sorting the candidate cells based on the signal quality parameters; and skipping selecting any intra-frequency cell of the target cell as a target cell within a set time in a case that the signal quality parameter of the target cell is less than a second signal quality parameter threshold and the signal quality parameter of the target cell ranks the first in the fifth sorting.

In an implementation, reselecting the new target cell for the UE includes: determining the candidate cell ranking the first in a fifth sorting in the candidate cells as the new target cell of the UE in a case that the signal quality parameter of the target cell is less than a second signal quality parameter threshold and the signal quality parameter of the target cell does not rank the first in the fifth sorting; determining the target cell as the new target cell of the UE in a case that the signal quality parameter of the target cell is greater than or equal to the second signal quality parameter threshold; or skipping selecting any intra-frequency cell of the target cell as a target cell within a set time in a case that the signal quality parameter of the target cell is less than the second signal quality parameter threshold.

In a second aspect, an example of the disclosure provides a cell reselection device. The device has a part of or all functions of a terminal device for implementing the method in the first aspect, for example, functions of a cell reselection device may have functions in a part of or all examples in the disclosure, or may have a function for independently implementing any example of the disclosure. The functions may be implemented through hardware or implemented by hardware executing corresponding software. The hardware or software includes one or more units or modules corresponding to the above functions.

In an implementation, a structure of a communication device may include a transceiving module and a processing module, and the processing module is configured to support the communication device to execute the corresponding functions in the above method. The transceiving module is configured to support the communication device to communicate with other devices. The communication device may also include a storage module, and the storage module is configured to be coupled with the transceiving module and the processing module and store computer program and data necessary for the communication device.

As an example, the processing module may be a processor, the transceiving module may be a transceiver or a communication interface, and the storage module may be a memory.

In a third aspect, an example of the disclosure provides a communication device, including a processor, and the processor, when calling a computer program in a memory, executes the above method in the first aspect.

In a fourth aspect, an example of the disclosure provides a communication device, including a processor and a memory, the memory stores a computer program, and the processor executes the computer program stored in the memory so as to cause the device to execute the above method in the first aspect.

In a fifth aspect, an example of the disclosure provides a communication device, including: a processor and an interface circuit; the interface circuit is configured to receive a code instruction and transmit the code instruction to the processor; and the processor is configured to run the code instruction so as to execute the above method in the first aspect.

In a sixth aspect, an example of the disclosure provides a communication system, including the cell reselection device in the second aspect, or including the communication device in the third aspect, or including the communication device in the fourth aspect, or including the communication device in the fifth aspect.

In a seventh aspect, an example of the disclosure provides a computer-readable storage medium, configured to store instructions, and the instructions, when executed, implement the above method in the first aspect.

In an eighth aspect, the disclosure further provides a computer program product including a computer program, and the computer program, when running on a computer, causes the computer to execute the above method in the first aspect.

In a ninth aspect, the disclosure provides a chip system, including at least one processor and interface and configured to support a terminal device to implement the functions involved in the first aspect, for example, determining or processing at least one type of data and information involved in the above method. In a possible design, the chip system further includes a memory, and the memory is configured to store computer programs and data necessary for the terminal device. The chip system may be composed of chips, or may also include a chip and other discrete devices.

In a tenth aspect, the disclosure provides a computer program, and the computer program, when running on a computer, causes the computer to execute the above method in the first aspect.

1. A cell reselection method, performed by user equipment (UE) and comprising:
determining a candidate cell;
determining a target cell of the UE according to slice information supported by the candidate cell; and
performing cell reselection according to the target cell.

2. The method according to claim 1, wherein determining the candidate cell comprises:
determining the candidate cell according to slice-specific network configuration information in a case that the slice-specific network configuration information is obtained; or
determining the candidate cell based on a signal quality parameter of a cell in a case that the slice-specific network configuration information is not obtained;
wherein the slice-specific network configuration information is carried by at least one of:
a broadcast system message or dedicated signaling.

3. The method according to claim 2, wherein the network configuration information comprises one or more configuration parameters, and determining the candidate cell according to the slice-specific network configuration information comprises:
using a cell meeting the one or more configuration parameters at the same time as the candidate cell,
wherein the configuration parameter comprises at least one of a slice-specific first signal quality parameter threshold, a number of slice-specific cells or a slice-specific signal quality deviation value, and
wherein the configuration parameter can be configured for at least one slice or at least one slice group.

4. (canceled)

5. The method according to claim 2, wherein the network configuration information comprises a slice-specific first signal quality parameter threshold, wherein determining the candidate cell according to the slice-specific network configuration information comprises:
determining a cell with a signal quality parameter being greater than or equal to the slice-specific first signal quality parameter threshold as the candidate cell.

6. The method according to claim 5, further comprising:
configuring first signal quality parameter thresholds for a same slice respectively based on different cells supporting the same slice, wherein the first signal quality parameter thresholds corresponding to the different cells are the same or not.

7. The method according to claim 2, wherein the network configuration information comprises a number N of slice-specific cells, wherein determining the candidate cell according to the slice-specific network configuration information comprises:
obtaining a first sorting of signal quality parameters of cells by sorting the cells according to the signal quality parameters; and
using top N cells in the first sorting as the candidate cells.

8. The method according to claim 2, wherein the network configuration information comprises a slice-specific signal quality deviation value, and determining the candidate cell according to the slice-specific network configuration information comprises:
determining a standard signal quality parameter of a cell ranking first in a first sorting of signal quality parameters of cells by sorting the cells according to the signal quality parameters; and
obtaining a difference between a signal quality parameter of any cell and the standard signal quality parameter, and determining the candidate cell in response to the difference being less than or equal to the deviation value.

9. (canceled)

10. The method according to claim 1, wherein determining the target cell of the UE according to the slice information supported by the candidate cell comprises:
determining one or more selection parameters in the slice information; and
determining the target cell from the candidate cell according to the one or more selection parameters, and
wherein the slice information supported by the candidate cell is carried by at least one of:
a broadcast system message or dedicated signaling.

11. (canceled)

12. The method according to claim 10, wherein determining the target cell from the candidate cell according to the one or more selection parameters comprises:
obtaining a first slice supported by the UE and a second slice supported by the candidate cell; and
determining the target cell from the candidate cell based on one or more selection parameters of the first slice and the second slice.

13. The method according to claim 10, wherein the one or more selection parameters comprises at least one of:
a slice priority, or the number of slices.

14. The method according to claim 13, wherein determining the target cell from the candidate cell based on the one or more selection parameters of the first slice and the second slice comprises:
obtaining a first target slice with the highest priority in the first slice based on the slice priority, and determining a candidate cell supporting the first target slice as a candidate target cell; or
intersecting the first slice and the second slice, obtaining second target slices with the greatest number of slices in the intersection, and determining the candidate cell supporting the second target slices as a candidate target cell; and
determining the target cell based on the candidate target cell.

15. The method according to claim 14, wherein determining the target cell based on the candidate target cell comprises:
determining the candidate target cell as the target cell in a case that the number of candidate target cells is 1; or
determining the target cell based on signal quality parameters of the candidate target cells in a case that the number of candidate target cells is greater than 1; or
determining the target cell based on a signal quality parameter of a cell in a case that the number of candidate target cells is 0.

16. The method according to claim 15, wherein determining the target cell based on the signal quality parameters of the candidate target cells in a case that the number of candidate target cells is greater than 1 comprises:
obtaining a second sorting of the signal quality parameters of the candidate target cells by sorting the candidate target cells based on the signal quality parameters in a case that a frequency of the candidate target cells and a frequency of a current cell to which the UE belongs belong to the same priority in at least one of intra-frequency and/or inter-frequency, and selecting and determining the candidate target cell ranking the first from the second sorting as the target cell; or
obtaining a second sorting of the signal quality parameters of the candidate target cells by sorting the candidate target cells based on the signal quality parameters in a case that the frequency of the candidate target cells and the frequency of the current cell to which the UE belongs belong to different priorities in at least one of intra-frequency and/or inter-frequency, selecting and determining the candidate target cell ranking the first and with the highest frequency priority from the second sorting as the target cell.

17. The method according to claim 15, wherein determining the target cell based on the signal quality parameter of the cell in a case that the number of candidate target cells is 0 comprises:
obtaining a third sorting of the signal quality parameter of the cell based on an existing mechanism and the signal quality parameter of the cell, and determining a cell ranking the first in the third sorting as the target cell; or
obtaining a fourth sorting of the signal quality parameters of the candidate cells based on the signal quality parameters of the candidate cells, and determining a candidate cell ranking the first in the fourth sorting from the candidate cells as the target cell.

18. The method according to claim 15, further comprising:
obtaining a signal quality parameter of the target cell; and
determining the target cell as a reselected cell of the UE, wherein the signal quality parameter of the target cell is greater than or equal to a second signal quality parameter threshold.

19. The method according to claim 18, further comprising:
reselecting a new target cell for the UE, wherein a signal quality parameter of the target cell is less than the second signal quality parameter threshold.

20. The method according to claim 19, wherein reselecting the new target cell for the UE comprises:
obtaining a fifth sorting by sorting the candidate cells based on signal quality parameters; and
skipping selecting any intra-frequency cell of the target cell as a target cell within a set time in a case that the signal quality parameter of the target cell is less than a second signal quality parameter threshold and the signal quality parameter of the target cell ranks the first in the fifth sorting.

21. The method according to claim 19, wherein reselecting the new target cell for the UE comprises:
determining the candidate cell ranking the first in a fifth sorting in the candidate cells as the new target cell of the UE in a case that the signal quality parameter of the target cell is less than a second signal quality parameter threshold and the signal quality parameter of the target cell does not rank the first in the fifth sorting;
determining the target cell as the new target cell of the UE in a case that the signal quality parameter of the target cell is greater than or equal to the second signal quality parameter threshold; or
skipping selecting any intra-frequency cell of the target cell as a target cell within a set time in a case that the signal quality parameter of the target cell is less than the second signal quality parameter threshold.

22-42. (canceled)

43. A communication device, comprising: a transceiver; a memory; and a processor, connected with the transceiver and the memory respectively and configured to control wireless signal transceiving of the transceiver by executing a computer executable instruction on the memory and enable implementing the following method;
determining a candidate cell;
determining a target cell of the UE according to slice information supported by the candidate cell; and
performing cell reselection according to the target cell.

44. A non-transitory computer-readable storage medium, wherein the computer storage medium stores a computer executable instruction, and the computer executable instruction, after being executed by a processor, can implement the following method;
determining a candidate cell;
determining a target cell of the UE according to slice information supported by the candidate cell; and
performing cell reselection according to the target cell.
